(19) United States
(12) Patent Application Publication
(10) Pub. No.: US 2021/0006064 A1
(43) Pub. Date: Jan. 7, 2021

(54) Transient Surge Monitoring

(71) Applicant: SIGNIFY HOLDING B.V., Eindhoven (NL)

(72) Inventors: Raymond George Janik, Fayetteville, GA (US); Russell Scott Trask, Sharpsburg, GA (US)

(21) Appl. No.: 16/503,311

(22) Filed: Jul. 3, 2019

(51) Int. Cl. H02H 9/04; H02H 9/00

(52) U.S. Cl. CPC H02H 9/042; H02H 9/005

(57) ABSTRACT

A surge monitoring circuit for detecting transient spikes in an input voltage includes a voltage divider circuit that generates a divider output voltage from the input voltage, a reference voltage generator circuit that generates reference voltages, and a comparator circuit that generates comparator signals by comparing the divider output voltage to the reference voltages. The surge monitoring circuit further includes a processor configured to predict, at least based on the comparator signals, an expected failure of a surge suppressor circuit that suppresses the transient spikes, where the comparator signals indicate detections of divider output transient spikes in the divider output voltage. The divider output transient spikes correspond to transient spikes in the input voltage, where the divider output transient spikes have a higher voltage than the one or more reference voltages.

### TECHNICAL FIELD

The present disclosure relates generally to power surge monitoring and more particularly, to predicting failures of power surge devices by monitoring power surges.

### BACKGROUND

Electrical transient surges may be the result of heavy electrical load switching or lightning strikes. A transient surge is generally characterized by a very large spike of voltage over a very short period of time. For example, a transient spike may have a duration between 10 μs to 1000 μs and may reach a peak voltage of 40 KV (kilovolts) or higher. Transient surges can cause damage to electrical components. Surge mitigation devices are commonly used to protect load devices from such power surges. However, a surge mitigation device generally has a life span that depends on the number of power surges that have reached the surge mitigation device. That is, a typical surge mitigation device has a limited number of power surge strikes that it can handle before failure. To illustrate, a metal oxide varistor (MOV) is commonly used for transient surge suppression and mitigation to protect electronic systems. As an MOV repeatedly absorbs power surge energy and converts the energy to heat, the MOV may experience structural fatigue. A single power surge may destroy an MOV that has experienced a significant structural fatigue. However, determining whether a surge mitigation device, such as an MOV or that includes an MOV, is close to failure may be challenging. Thus, a solution that enables predicting the failure of surge mitigation devices may be desirable.

### SUMMARY

The present disclosure relates generally to power surge monitoring and more particularly, to predicting failures of power surge devices by monitoring power surges. In an example embodiment, a surge monitoring circuit for detecting transient spikes in an input voltage includes a voltage divider circuit that generates a divider output voltage from the input voltage, a reference voltage generator circuit that generates one or more reference voltages, and a comparator circuit that generates one or more comparator signals by comparing the divider output voltage to the one or more reference voltages. The surge monitoring circuit further includes a processor configured to predict, at least based on the one or more comparator signals, an expected failure of a surge suppressor circuit that suppresses the transient spikes, where the one or more comparator signals indicate one or more detections of one or more divider output transient spikes in the divider output voltage. The one or more divider output transient spikes correspond to one or more transient spikes of the transient spikes, where the one or more divider output transient spikes have a higher voltage than the one or more reference voltages.

In another example embodiment, a surge suppression and monitoring device includes a surge suppressor circuit to suppress transient spikes in an input voltage, and a surge monitoring circuit. The surge monitoring circuit includes a voltage divider circuit that generates a divider output voltage from the input voltage, a reference voltage generator circuit that generates one or more reference voltages, and a comparator circuit that generates one or more comparator signals by comparing the divider output voltage to the one or more reference voltages. The surge monitoring circuit further includes a processor configured to predict an expected failure of the surge suppressor circuit at least based on the one or more comparator signals.

In another example embodiment, a method of monitoring transient spikes in an input voltage includes generating, by a voltage divider circuit, a divider output voltage from the input voltage, where the divider output voltage includes one or more divider output transient spikes that correspond to one or more transient spikes of the transient spikes. The method further includes generating, by a reference voltage generator circuit, one or more reference voltages, and generating, by a comparator circuit, one or more comparator signals by comparing the divider output voltage to the one or more reference voltages. The method also includes providing, by a processor, a notification indicating an expected failure of a surge suppressor circuit that suppresses the one or more transient spikes, where the processor is configured to predict the expected failure of the surge suppressor circuit at least based on the one or more comparator signals.

These and other aspects, objects, features, and embodiments will be apparent from the following description and the appended claims.

### BRIEF DESCRIPTION OF THE DRAWINGS

The foregoing and other features and aspects of the disclosure are best understood with reference to the following description of certain example embodiments, when read in conjunction with the accompanying drawings, wherein:

FIG. 1 illustrates a surge suppression and monitoring device according to an example embodiment;

FIG. 2 illustrates a surge monitoring circuit of the surge suppression and monitoring device of FIG. 1 according to an example embodiment;

FIG. 3 illustrates a divider circuit of the surge monitoring circuit of FIG. 2 according to another example embodiment;

FIG. 4 illustrates a reference voltage generator circuit of the surge monitoring circuit of FIG. 2 according to another example embodiment;

FIG. 5 illustrates a waveform of a divider output voltage generated by the divider circuit of FIGS. 2 and 3 according to another example embodiment;

FIG. 6 illustrates a method of monitoring transient spikes according to another example embodiment;

FIG. 7 illustrates a transformer of the power supply device of the surge suppression and monitoring device of FIG. 1 according to an example embodiment;

FIG. 8 illustrates the power supply device of the surge suppression and monitoring device 100 of FIG. 1 showing an equivalent circuit of the transformer of FIG. 7 according to an example embodiment;

FIG. 9 illustrates a surge monitoring system that includes multiple surge monitoring devices according to another example embodiment; and

FIG. 10 illustrates a geographic map of an area with surge monitoring devices according to another example embodiment.

The drawings illustrate only example embodiments and are therefore not to be considered limiting in scope. The elements and features shown in the drawings are not necessarily to scale, emphasis instead being placed upon clearly illustrating the principles of the example embodiments. Additionally, certain dimensions or placements may be exaggerated to help visually convey such principles. In the figures, the same reference numerals designate like or corresponding, but not necessarily identical, elements.

### DETAILED DESCRIPTION OF EXAMPLE EMBODIMENTS

In the following paragraphs, particular embodiments will be described in further detail by way of example with reference to the figures. In the description, well known components, methods, and/or processing techniques are omitted or briefly described. Furthermore, reference to various feature(s) of the embodiments is not to suggest that all embodiments must include the referenced feature(s).

In some example embodiments, a surge monitoring device may anticipate a failure of a power suppression device and may send a signal indicating that the power suppression device needs to be replaced soon. For example, the surge monitoring device may predict the anticipated failure based on the number of transient spikes and/or the duration of the transient spikes. The surge monitoring device may also provide a visual notification and/or an audio notification indicating that the power suppression device is expected to fail soon (e.g., after one more power surge). The surge monitoring device may also transmit information indicating occurrences of transient spikes. For example, a server of a surge monitoring system may record transient spike occurrences indicated by the surge monitoring device and may provide a notification indicating the power suppression device associated with the surge monitoring device is expected to fail soon and/or should be replaced. The surge monitoring system may also include multiple surge monitoring devices and may receive information from the individual surge monitoring devices indicating transient spike occurrences. For example, the server of the surge monitoring system may process the information received from the multiple surge monitoring devices over time and may provide information regarding transient spike occurrences and associated surge monitoring devices, geographic areas, etc.

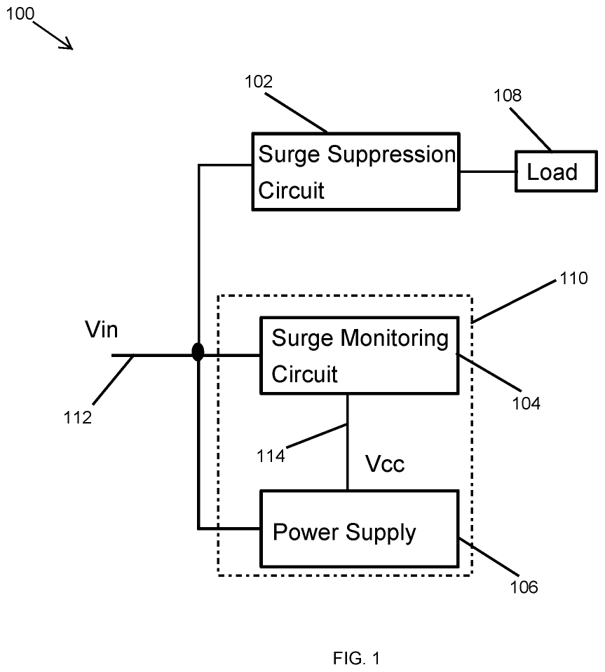

Turning now to the drawings, FIG. 1 illustrates a surge suppression and monitoring device 100 according to an example embodiment. In some example embodiments, the surge suppression and monitoring device 100 includes a surge suppression circuit 102, a surge monitoring circuit 104, and a power supply device 106. The surge suppression circuit 102, the surge monitoring circuit 104, and the power supply device 106 may receive a line input voltage Vin on an electrical connection 112 (e.g., one or more electrical wires). For example, the input voltage Vin may range between 120 VAC and 277 VAC. As another example, the input voltage Vin may be 480 VAC or higher. In some cases, transient spikes in the input voltage Vin may reach 40 KV or higher.

In some example embodiments, the surge suppression circuit 102 may provide protection to a load device 108 from the transient spikes in the input voltage Vin. For example, the surge suppression circuit 102 may include an MOV that operates to clamp the voltage at the load device 108 at a safe level. Alternatively, the surge suppression circuit 102 may include another component instead of or in addition to the MOV to provide protection to the load device 108 from transient spikes in the input voltage Vin.

In some example embodiments, the surge monitoring circuit 104 may detect the transient spikes in the input voltage Vin and may determine whether the surge suppression circuit 102 is close to failure based on the detected spikes. For example, the surge monitoring circuit 104 may determine, based on the number of detected transient spikes, whether the surge suppression circuit 102 is likely to fail. Alternatively or in addition, the surge monitoring circuit 104 may also determine whether the surge suppression circuit 102 is likely to fail based on the number and amplitudes of the detected transient spikes. Alternatively or in addition, the surge monitoring circuit 104 may determine whether the surge suppression circuit 102 is likely to fail based on the number, amplitudes, and/or durations of the detected transient spikes.

In some example embodiments, the number, amplitudes, and durations of transient spikes in the input voltage Vin that may cause the surge suppression circuit 102 to fail may be determined experimentally or based on calculations that consider the characteristics of the surge suppression circuit 102. For example, information including indicating or corresponding to the different parameters (e.g., number, amplitudes, and durations of transient spikes, etc.) and different permutations of these parameters may be stored in the surge monitoring circuit 104 that uses the information to determine whether the surge suppression circuit 102 is likely to fail based on the detection of transient spikes.

In some example embodiments, the surge monitoring circuit 104 may transmit a notification, for example, to a server or a user device indicating that the surge suppression circuit 102 should be replaced or is likely to fail soon. Alternatively or in addition, the surge monitoring circuit 104 may provide a local notification indicating that the surge suppression circuit 102 should be replaced or is likely to fail soon. For example, the surge monitoring circuit 104 may provide a visual notification (e.g., a light, a displayed message, etc.) and/or an audio notification (e.g., a buzzer sound, recorded message, etc.).

In some example embodiments, instead of or in addition to providing notifications, the surge monitoring circuit 104 may transmit information indicating detections of transient spikes, amplitudes, and/or durations. The surge monitoring circuit 104 may also transmit a time stamp indicating the time of detection of individual transient spikes. A server or a user device may receive and process the information from the surge monitoring circuit 104 in a similar manner as described with respect to the surge monitoring circuit 104. To illustrate, a server or a user device may determine whether the surge suppression circuit 102 should be replaced or is likely to fail soon based on the number, amplitudes, and/or durations of the detected transient spikes as indicated by the information received from the surge monitoring circuit 104. The server or the user device may also record at least some of the information received from the surge monitoring circuit 104 and may provide historical information (e.g., the number and frequency of transient spikes) related to the surge suppression circuit 102.

In some example embodiments, the power supply device 106 provides power to the surge monitoring circuit 104. For example, the power supply device 106 may provide a supply voltage Vcc to the surge monitoring circuit 104 via an electrical connection 114 (e.g., one or more electrical wires or traces). The power supply device 106 generates the supply voltage Vcc from the input voltage Vin and may be exposed to the transient spikes experienced by the surge suppression circuit 102. To reliably generate the supply voltage Vcc from the input voltage Vin, the power supply device 106 includes a high leakage isolation linear transformer as described below.

By providing one or more notifications indicating that the surge suppression circuit 102 needs to be replaced and/or is likely to fail, risk of unexpected failures of the surge suppression circuit 102 may be reduced or avoided. By transmitting information indicating and/or otherwise related to the detections of transient spikes in the input voltage Vin, another device, such as a server or a user device, may process the information and determine whether the surge suppression circuit 102 needs to be replaced and/or is likely to fail and reduce the risk of unexpected failures of the surge suppression circuit 102. By collecting information related to the transient spikes, historical information may be used to make decisions such as the type of surge suppression circuit or device that should be used in a particular area, for example, based on the frequency and other characteristics of transient spikes.

In some example embodiments, high dielectric strength insulated cables may be used for electrical connections, for example, in order to reduce leakage. In some alternative embodiments, the surge suppression circuit 102, the surge monitoring circuit 104, and the power supply device 106 may be separate devices or may be integrated in the surge suppression and monitoring device 100. In some example embodiments, the surge monitoring circuit 104 and the power supply device 106 may be integrated in a single device 110 that is separate from the surge suppression circuit 102. In some alternative embodiments, the input voltage Vin may be provided to the surge suppression circuit 102, the surge monitoring circuit 104, and the power supply device 106 via separate electrical connections that branch off the electrical connection 112 outside of the surge suppression and monitoring device 100. In some alternative embodiments, the input voltage Vin may exceed 300 VAC. In some example embodiments, the surge suppression and monitoring device 100 may be used in outdoor applications. Alternatively or in addition, the surge suppression and monitoring device 100 may be used in indoor applications.

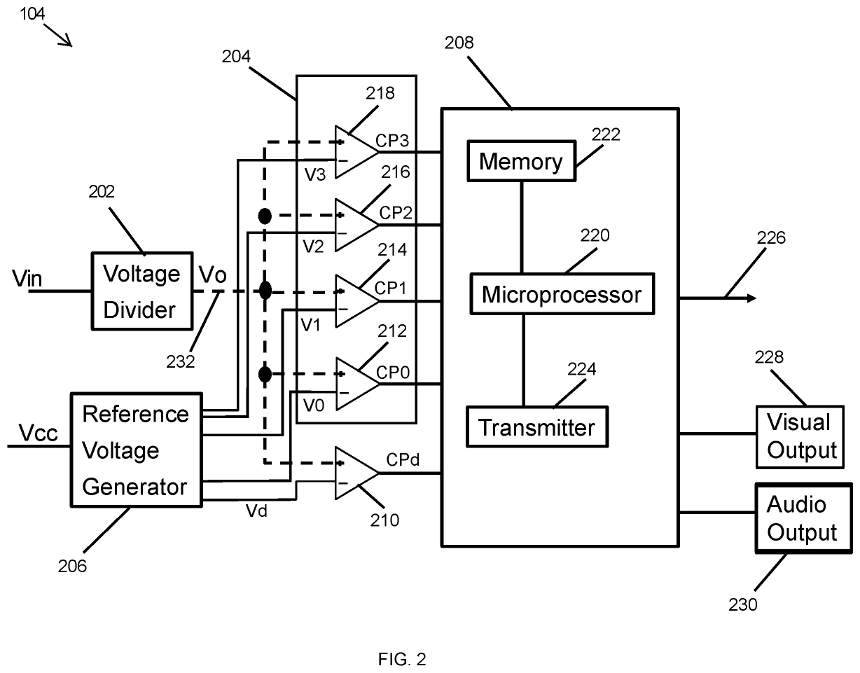

FIG. 2 illustrates the surge monitoring circuit 104 of the surge suppression and monitoring device 100 of FIG. 1 according to an example embodiment. Referring to FIGS. 1 and 2, in some example embodiments, the surge monitoring circuit 104 includes a voltage divider circuit 202, a comparator circuit 204, a reference voltage generator circuit 206, and a processor unit 208. The surge monitoring circuit 104 may also include a comparator 210 that is used to determine durations of transient spikes. The surge monitoring circuit 104 may further include a visual output interface 228 and an audio output interface 230.

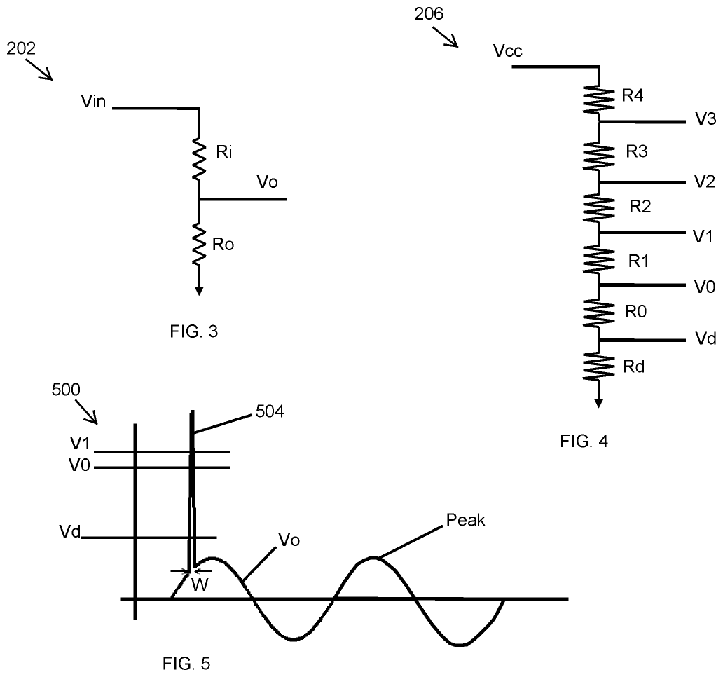

In some example embodiments, the voltage divider circuit 202 may receive the input voltage Vin and generate a divider output voltage Vo. To illustrate, the input voltage Vin is stepped down to the divider output voltage Vo by the voltage divider circuit 202. For example, the voltage divider circuit 202 may include resistors Ri and Ro that are connected as shown in FIG. 3. Referring to FIGS. 1-3, the voltage level of the divider output voltage Vo depends on the values of the resistors Ri and Ro. For example, the values of the resistors Ri and Ro may be selected such that the ratio of the divider output voltage Vo to the input voltage Vin is approximately 1:10,000. For example, the divider output voltage Vo may be approximately 4 V when a transient spike in the input voltage Vin is 40 KV. As another example, the divider output voltage Vo may be approximately 170 mV when the input voltage Vin has an amplitude of 170 V. To tolerate the high amplitudes of the transient spikes in the input voltage Vin, the resistor Ri may be rated to over 50 KV. As shown in FIG. 2, the divider output voltage Vo is provided to comparator circuit 204 via an electrical connection 232 (e.g., one or more electrical wires).

In some example embodiments, the voltage divider circuit 202 may receive the supply voltage Vcc from the power supply device 106 and generate reference voltages V0, V1, V2, V3 as well as a reference voltage Vd that is used to determine durations of transient spikes. The voltage divider circuit 202 may include resistors R0, R1, R2, R3 as well as a resistor Rd as shown in FIG. 4.

Referring to FIGS. 1, 2, and 4, the resistors R0-R3 and Rd may be connected in a voltage divider configuration as shown in FIG. 4 to generate the reference voltages V0-V3 and Vd. The resistors R0-R3 are connected such that the voltage levels of the reference voltages V0-V3 are in an increasing order starting from the reference voltage V0, which has the lowest voltage level of the reference voltages V0-V3. The values of the resistors R0-R3 and Rd may be selected based on the voltage level of the supply voltage Vcc and the desired values of the reference voltages V0-V3 and Vd as can be readily understood by those of ordinary skill in the art with the benefit of this disclosure. For example, the values of the resistors R0-R3 may be selected such that the reference voltages V0-V3 are equally spaced (in volts) from each other. Alternatively, the values of the resistors R0-R3 may be selected such that some of the reference voltages V0-V3 are not equally spaced (in volts) from each other.

As shown in FIG. 2, the reference voltages V0-V3 and Vd may be provided to the comparator circuit 204. The comparator circuit 204 may include comparators 212-218. The divider output voltage Vo may be provided to each of the comparator 212-218 as well as the comparator 210. For example, the divider output voltage Vo may be provided to the positive input of each comparator 212-218. The reference voltage V0 is provided to the comparator 212, the reference voltage V1 is provided to the comparator 214, the reference voltage V2 is provided to the comparator 216, and the reference voltage V3 is provided to the comparator 218. The reference voltage Vd is provided to the comparator 210 for the purpose of generating a pulse when a transient spike in the divider voltage output Vo equals or exceeds the reference voltage Vd. Example voltage levels of the reference voltages Vd and V0 are shown in FIG. 5.

Referring to FIGS. 1-5, in some example embodiments, the divider voltage output Vo generated by the voltage divider circuit 202 from the line input voltage Vin may include a divider voltage output transient spike 504. For example, the transient spike 504 may correspond to a transient spike in the input voltage Vin and may be 1/10000 of the input voltage Vin. For example, the maximum amplitude of the transient spike 504 may be 3 volts (V) and may correspond to a maximum amplitude of a 30 KV of a corresponding transient spike in the input voltage Vin. The reference voltage V0 may be, for example, at 1 V corresponding to 10 KV level of the transient spike in the input voltage Vin, and the reference voltage Vd may be 50 mV corresponding to 500 V level of the transient spike in the input voltage Vin. As another example, the reference voltage Vd may be 100 mV corresponding to 1000 V level of the transient spike in the input voltage Vin.

In some example embodiments, excluding the transient spike 504, the peak amplitude of the divider voltage output Vo may be, for example, 17 my and may reflect a 170 V peak amplitude of the input voltage Vin. As another example, the peak amplitude of the divider voltage output Vo may be, for example, approximately 39 mV and may reflect an approximately 392 V peak amplitude of the input voltage Vin exclusive of the transient spike 504. In general, the amplitude of the divider voltage output Vo may follow the amplitude of the input voltage Vin based on a ratio dictated by the values of the resistors Ri and Ro shown in FIG. 3.

In some example embodiments, each of the comparators 212-218 may compare the divider output voltage Vo to the respective one of the reference voltages V0-V3 and generate a respective comparator signal CP0-CP3 that indicates whether the divider output voltage Vo equals or exceeds the respective one of the reference voltages V0-V3. For example, the comparator 212 may compare the reference voltage V0 to the divider output voltage Vo and generate the comparator signal CP0 with a signal value indicating (e.g., a digital high value) that the divider output voltage Vo equals or exceeds the reference voltage V0 for the duration that the divider output voltage Vo equals or exceeds the reference voltage V0. A signal value of the comparator signal CP0 that indicates that the divider output voltage Vo equals or exceeds the reference voltage V0 is an indication of a transient spike in the line voltage input Vin. The comparator 214 may compare the reference voltage V1 to the divider output voltage Vo and generate the comparator signal CP1 in a similar manner as CP0. A signal value of the comparator signal CP1 that indicates that the divider output voltage Vo equals or exceeds the reference voltage V1 is an indication of a transient spike in the line voltage input Vin that equals or exceeds an amplitude that is proportional to the reference voltage V1. The comparator 216 may compare the reference voltage V2 to the divider output voltage Vo and generate the comparator signal CP2 in a similar manner, and the comparator 218 may compare the reference voltage V3 to the divider output voltage Vo and generate the comparator signal CP3 in a similar manner. As shown in FIG. 2, the comparator signals CP0-CP3 are provided to the processor unit 208.

In some example embodiments, the comparator 210 may compare the divider output voltage Vo to the reference voltage Vd and generate a duration indicator signal CPd that includes a pulse having a pulse width that corresponds to the duration W of the transient spike 504 at the reference voltage Vd. The comparator 210 may generate a pulse for each divider output voltage transient spike, such as the divider output voltage transient spike 504, that meets or exceeds the reference voltage Vd. The duration indicator signal CPd is provided to the processor unit 208.

Because the divider output voltage Vo, including the divider output voltage transient spike 504, proportionally corresponds to the line input voltage Vin and because the reference voltages V0-V3 may be selected to correspond to particular voltage levels of transient spikes in the line input voltage Vin, the comparator signals CP0-CP3 may reliably indicate whether the maximum amplitudes of transient spikes in the line input voltage Vin equal or exceed particular voltage levels corresponding to the reference voltages V0-V3. That is, the comparator signals CP0-CP3 may indicate the detection of the transient spikes in the line input voltage Vin. Further, because the comparator 210 generates a pulse when the divider output voltage Vo equals or exceeds the reference voltage Vd that proportionally corresponds to a voltage level of a transient spike in the input voltage Vin, the pulse width of the generated pulse indicates the duration of the transient pulse at the voltage level of the transient spike in the input voltage Vin.

In some example embodiments, the processor unit 208 may include a microprocessor 220, a memory device 222, and a transmitter 224. For example, the microprocessor 220 may execute software code stored in the memory device 222 and use data stored in the memory device 222 to implement some of the operations described herein with respect to the processor unit 208. The microprocessor 220 may receive the comparator signals CP0-CP3 and the duration indicator signal CPd and process comparator signals CP0-CP3 and/or the duration indicator signal CPd to determine/predict whether the surge suppression circuit 102 is close to failing or needs to be replaced.

In some example embodiments, because transient spikes in the input voltage Vin detected by the surge monitoring circuit 104 are experienced by the surge suppression circuit 102, the microprocessor 220 may predict whether the surge suppression circuit 102 is close to failing or needs to be replaced based on the number of detected transient spikes, the amplitudes of the detected transient spikes, and/or the durations of the detected transient spikes. To illustrate, the microprocessor 220 may keep track of the number of detected transient spikes in the input voltage Vin indicated by the comparator signals CP0-CP3 for the like of the surge suppression circuit 102. The microprocessor 220 may determine that the surge suppression circuit 102 is close to failing or needs to be replaced based on the number of detected transient spikes in the input voltage Vin. For example, the microprocessor 220 may use experimentally determined and/or calculated data stored in the memory device 222 regarding the tolerance of the surge suppression circuit 102 to transient spikes to determine whether a particular number of detected transient spikes indicates that the surge suppression circuit 102 is close to failing.

In some example embodiments, the microprocessor 220 also keep track of the amplitudes of detected transient spikes indicated by the comparator signals CP0-CP3 based on which ones of the comparator signals CP0-CP3 indicate the individual transient spikes. For example, the microprocessor 220 may determine that the surge suppression circuit 102 is close to failing after the detection of a number of transient spikes having higher amplitudes and may determine that the surge suppression circuit 102 is not close to failing after the detection of the same number of transient spikes having lower amplitudes.

To illustrate, the comparator signals CP0-CP3 indicate different amplitudes of a transient spike in an increasing order from the comparator signal CP0 to the comparator signal CP3. For example, the detection of a transient spike indicated by the comparator signal CP0 but not by the other comparator signals CP1-CP3 indicates that the peak amplitude of the transient spike in the input voltage Vin is higher than the voltage corresponding to the reference voltage V0 and less the voltage corresponding to the reference voltages V1-V3. As another example, the detection of a transient spike indicated by the comparator signals CP0 and CP1 but not by the other comparator signals CP2 and CP3 indicates that the peak amplitude of the transient spike in the input voltage Vin is higher than the voltage corresponding to the reference voltage V1 and less the voltage corresponding to the reference voltages V2 and V3. By using information about the amplitudes of detected transient spikes, the microprocessor 220 may more reliably determine whether the surge suppression circuit 102 is close to failing.

In some example embodiments, the microprocessor 220 also keep track of the duration of the transient spikes based on the pulse widths of the pulses of the duration indicator signal CPd. For example, because a transient spike that has a longer duration carries more energy and can cause more damage to the surge suppression circuit 102 than a shorter duration transient spike, the microprocessor 220 may determine that the surge suppression circuit 102 is close to failing after the detection of a fewer number of transient spikes having longer durations than the detection of a greater number of transient spikes having shorter durations.

In some example embodiments, the microprocessor 220 may record the detections of transient spikes, for example, in the memory device 222. The microprocessor 220 may transmit transient spike detection information indicating each individual detection of a transient spike. For example, every time one or more of the comparator signals CP0-CP3 indicate a transient spike in the voltage divider output Vo (which corresponds to a transient spike in the input voltage Vin as described above), the microprocessor 220 may transmit, via the transmitter 224, information indicating the detection of the transient spike. In general, the arrow 226 illustratively represents wired and/or wireless transmissions by the processor unit 208.

In some example embodiments, the microprocessor 220 may record amplitudes of detected transient spikes, for example, in the memory device 222. For example, the amplitude of a detected transient spike may be represented as falling within a range of amplitude values (e.g., between two of the reference voltages V0-V3 (or mapped to corresponding voltage levels with respect to the input voltage Vin). As another example, the amplitude of a detected transient spike may be represented as being above an amplitude value (e.g., above one of the reference voltages V0-V3 (or mapped to a corresponding voltage level with respect to the input voltage Vin). In general, the amplitude of a detected transient spike may be represented in a manner that is generally indicative of the amplitude/voltage level of the detected transient spike. In some example embodiments, the microprocessor 220 may transmit, via the transmitter 224, amplitude information each detection of a transient spike.

In some example embodiments, the microprocessor 220 may determine durations of transient spikes by processing the duration indicator signal CPd to determine pulse widths of pulses of the duration indicator signal CPd. As described above, the pulse widths correspond to the width of the voltage divider output transient spikes at the reference voltage Vd that proportionally corresponds to a voltage level of transient spikes in the input voltage Vin. In some example embodiments, the widths of the voltage divider output transient spikes at the reference voltage Vd may closely match the widths of the transient spikes in the input voltage Vin at a voltage level that is proportional to the reference voltage Vd. In some example embodiments, when a transient spike is detected as indicted by the comparator signals CP0-CP3, the microprocessor 220 may store and/or transmit, via the transmitter 224, the transient spike duration information indicating the duration of the detected transient spike.

In some example embodiments, the microprocessor 220 may record time information when one or more of the comparator signals CP0-CP3 indicate a transient spike. For example, the time information may include date and the time of the day at which a transient spike is detected. The microprocessor 220 may transmit, via the transmitter 224, a timestamp (i.e., the time information) along with other information, such as the transient spike detection information, the amplitude information, and/or the transient spike duration information.

In some example embodiments, the microprocessor 220 may transmit a trigger/valid signal as an indication to a receiving device that the other information transmitted at the surge monitoring circuit 104 is valid. For example, a receiving device (e.g., a local or remote server or a user device) may process the other information received from the surge monitoring circuit 104 only if the trigger/valid signal indicates (e.g., a pulse) that the information is valid.

In some example embodiments, the microprocessor 220 may transmit, via the transmitter 224, a notification, for example, to a server or a user device indicating that the surge suppression circuit 102 is likely to fail soon or should be replaced. As explained above, the microprocessor 220 may transmit determine whether the surge suppression circuit 102 is likely to fail soon based on experimentally determined and/or calculated (e.g., interpolated and extrapolated) data and the number of detected transient spikes, the amplitudes of the detected transient spikes, the durations of the detected transient spikes, etc.

In some example embodiments, the microprocessor 220 may provide a local notification indicating that the surge suppression circuit 102 should be replaced or is likely to fail soon. For example, the surge monitoring circuit 104 may provide a visual notification (e.g., a light, a displayed message, etc.) via the visual output interface 228 and/or an audio notification (e.g., a buzzer sound, recorded message, etc.) via the audio output interface 230. For example, the visual output interface 228 may include one or more light source that emit a notification light, a display screen to display a notification message, etc. The audio output interface 230 may include an annunciator that the provides an audio notification.

In some alternative embodiments, the comparator circuit 204 may include more or fewer comparators than shown without departing from the scope of this disclosure. For example, the comparator circuit 204 may include one, two, three, or five comparators. In some alternative embodiments, the reference voltage generator circuit 206 may generate more or fewer reference voltages than shown without departing from the scope of this disclosure. In some example embodiments, the ratio of the input voltage Vin to the divider output voltage Vo may be more or less than 1:10000. In some alternative embodiments, the surge monitoring circuit 104 and/or individual components of the surge monitoring circuit 104 may include other components or components that connected in a different configuration than shown without departing from the scope of this disclosure. In some alternative embodiments, one or more of the components of the surge monitoring circuit 104 may be omitted without departing from the scope of this disclosure. In some alternative embodiments, the waveform of the divider output voltage Vo, including the transient spike 504, may be different than shown in FIG. 5 without departing from the scope of this disclosure. In some alternative embodiments, the configuration of resistors of the voltage divider circuit 202 and the reference voltage generator circuit 206 may different than shown in FIGS. 4 and 5, respectively, without departing from the scope of this disclosure.

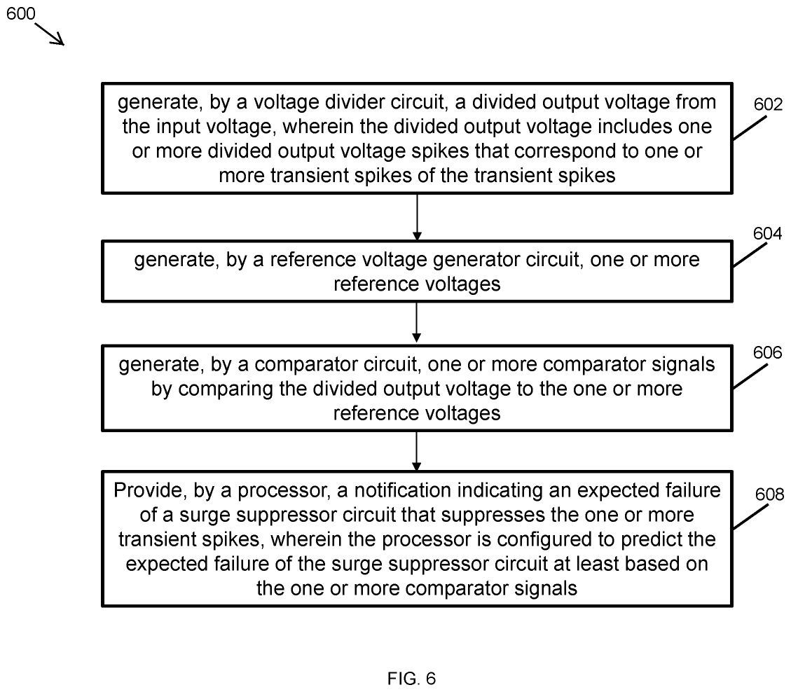

FIG. 6 illustrates a method 600 of monitoring transient spikes according to another example embodiment. Referring to FIGS. 1-5, at step 602, the method 600 includes generating, by the voltage divider circuit 202, the divided output voltage Vo from the input voltage Vin. The divided output voltage Vo includes one or more divided output voltage spikes (e.g., the transient spike 504) that correspond to one or more transient spikes of the transient spikes in the input voltage Vin. At step 604, the method 600 includes generating, by the reference voltage generator circuit 206, one or more reference voltages V0-V3.

In some example embodiments, at step 606, the method 600 includes generating, by the comparator circuit 204, one or more comparator signals CP0-CP3 by comparing the divided output voltage Vo to the one or more reference voltages V0-V3. At step 608, the method 600 includes providing, by the processor unit 208, a notification indicating an expected failure of a surge suppressor circuit 102. The processor unit 208 is configured to predict the expected failure of the surge suppressor circuit at least based on the one or more comparator signals CP0-CP3. For example, the processor unit 208 may record detections of transient surges as indicated by one or more comparator signals CP0-CP3 and predict the expected failure of the surge suppressor circuit at least based on the number of detected transient surges.

In some example embodiments, the method 600 includes predicting, by the processor unit 208, the expected failure of the surge suppressor circuit 102 based on one or more amplitudes of the one or more divider output transient spikes as indicated by comparator signals CP0-CP3. The processor unit 208 may also be configured to predict the expected failure of the surge suppressor circuit 102 further based on one or more durations of the one or more divider output transient spikes at the voltage level of the reference voltage Vd with respect to the divider output voltage Vo.

In some example embodiments, the method 600 may also include generating, by the power supply device 106, a supply voltage Vcc from the input voltage Vin. The one or more reference voltages V0-V3 may be generated by the reference voltage generator circuit 206 from the supply voltage Vcc, for example, as shown in FIG. 4.

In some example embodiments, some of the steps of the method 600 may be performed in a different order than described above without departing from the scope of this disclosure. In some alternative embodiments, the method 600 may include more or fewer steps without departing from the scope of this disclosure.

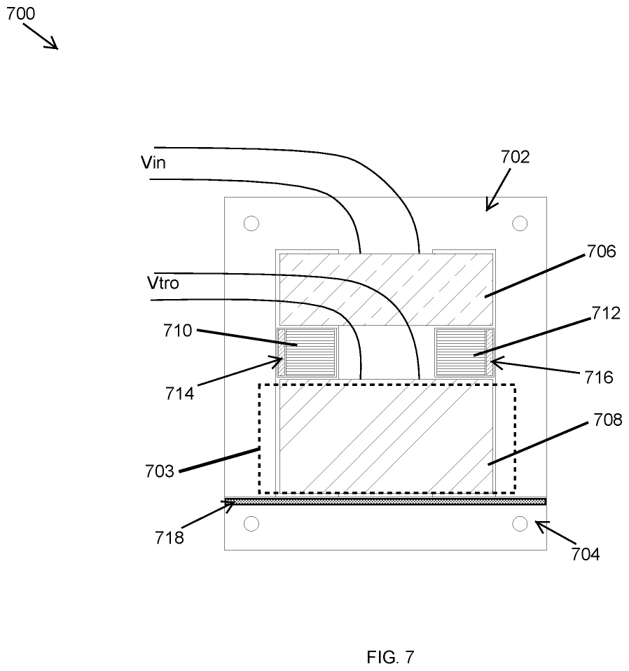

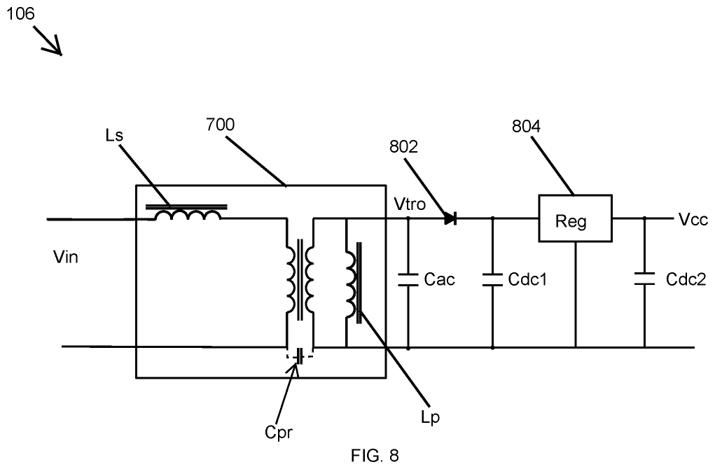

FIG. 7 illustrates a transformer 700 of the power supply device 106 of the surge suppression and monitoring device 100 of FIG. 1 according to an example embodiment. FIG. 8 illustrates the power supply device 106 of the surge suppression and monitoring device 100 of FIG. 1 showing an equivalent circuit of the transformer 700 of FIG. 7 according to an example embodiment. Referring to FIGS. 1-8, in some example embodiments, the transformer 700 may steps the input voltage Vin to a desired low voltage, such as between 5V and 24V. As illustrated in FIG. 7, the transformer 700 includes a core that includes core segments 702, 704, a primary winding 706, and a secondary winding 708. Magnetic shunts 710, 712 may include gaps 714, 716, respectively in the magnetic path, separating the primary winding 706 and the secondary winding 708. The magnetic shunts 710, 712 enable the magnetic flux at the primary winding 706 to be different from the magnetic flux at the secondary winding 708 by increasing the leakage inductance between the two windings.

In some example embodiments, a series inductance Ls (shown in FIG. 8) depends on the coupling between the primary winding 706 and the secondary winding 708. To increase leakage between the winding 706, 708, the windings 706, 708 can be physically separated by a dielectric material. To illustrate, the shunt gaps 714, 716 which is the portions of the transformer window width that is not occupied by the magnetic shunts 710, 712 may be filled with a non-electromagnetic material, such as Nomex. The gaps 714, 716 may result in the series inductance Ls having a large enough value to provide adequate leakage. The separation between the primary and secondary windings also reduce the parasitic capacitance Cpr between the primary winding 706 and the secondary winding 708, which results in less current being induced in the secondary winding by a transient voltage level of the input voltage Vin.

In some example embodiments, the core segment 702 may be separated from the core segment 704 by a gap 718. The gap 718 may be an air gap or may be filled with a non-electromagnetic material, such as Nomex. For example, because the parallel inductance Lp shown in FIG. 8 depends on the gap 718, the gap 718 may be sized such that the parallel inductance Lp has a value that can be determined. The exact size of the gap 718 may depend on the dimensions of the core segment 702 as can be readily understood by those of ordinary skill in the art with the benefit of this disclosure. The parallel inductance Lp accounts for the magnetizing inductance of the transformer 700. The parallel inductance Lp and capacitor Cac establish a parallel resonance circuit that acts as a narrow band pass filter centered at 50 Hz or 60 Hz.

In some example embodiments, a diode 802 may rectify the output voltage Vtro of the transformer 700, and a regulator 804 (e.g., a linear regulator) may generate a regulated DC voltage, i.e., the supply voltage Vcc, from the rectified output voltage provided by the diode 802. The supply voltage Vcc may be, for example, between approximately 5V and 24V. The capacitors Cdc1 and Cdc2 operate to smooth out the respective voltages as can be readily understood by those of ordinary skill in the art with the benefit of this disclosure.

When the input voltage Vin is provided to the primary winding 706, the voltage at the secondary winding 708 increases, due to series resonance of Ls and Cac, until the portion 703 of the core segment 702 at the secondary winding 708 is saturated while the portion of the core at the primary winding 706 remains unsaturated. If a high transient voltage spike is present in the input voltage Vin, the series inductance Ls stands-off the surge voltage. The high dielectric low capacitance isolation between the primary winding 706 and the secondary winding 708 can significantly limit the induced current that is dumped in the series inductance Ls-capacitance Cac resonance tank circuit. The series inductor Ls, the parallel inductor Lp, and capacitor Cac can form a high Q factor low pass filter of 60 Hz corner frequency.

Be suppressing transient voltage spikes that may be present in the input voltage Vin, the power supply device 106 provides the supply voltage Vcc to the surge monitoring circuit 104 at a safe voltage level. By generating the supply voltage Vcc from the input voltage Vin while suppressing transient voltage spikes, the supply voltage Vcc avoids the need for a separate power source.

In some alternative embodiments, the power supply device 106 may include other components without departing from the scope of this disclosure. In some example embodiments, one or more components of the power supply device 106 may be omitted or may be connected in a different configuration without departing from the scope of this disclosure.

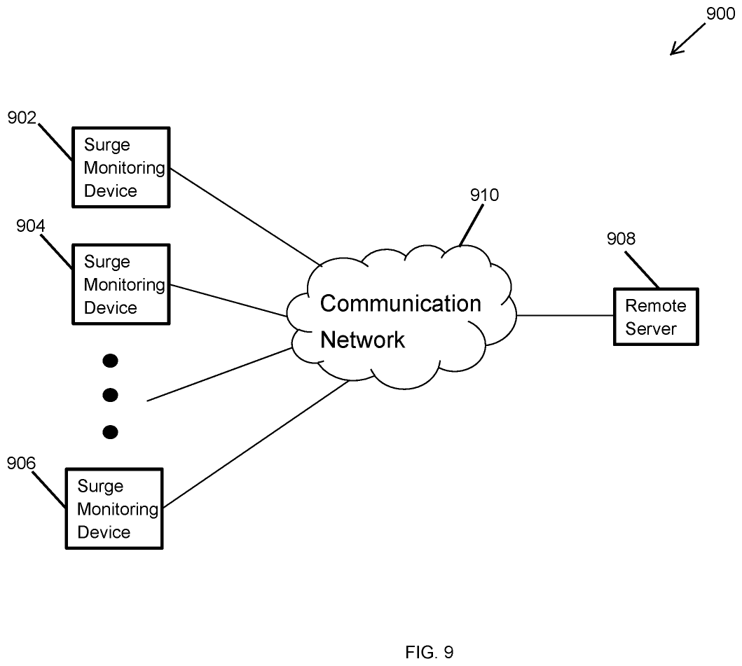

FIG. 9 illustrates a surge monitoring system 900 that includes multiple surge monitoring devices according to another example embodiment. Referring to FIGS. 1-9, in some example embodiments, the system 900 includes multiple surge monitoring devices including surge monitoring devices 902, 904, 906 that each correspond to the surge monitoring circuit 104 of FIG. 1. For example, each one of the surge monitoring devices 902, 904, 906 may be coupled to a respective surge suppression circuit, such as the surge suppression circuit 102, and may determine whether the surge suppression circuit 102 is close to failure based on detected transient spikes in the respective input voltage provided to each surge monitoring devices 902, 904, 906 and associated surge suppression circuits.

In some example embodiments, the system 900 may also include a remote server 908 that receives from the surge monitoring devices 902, 904, 906 information related to transient spikes, surge suppression circuits, etc. through a communication network 910. The communication network 910 may include local area network, a wired and/or wireless network, the internet, etc. as can be readily understood by those of ordinary skill in the art with the benefit of this disclosure. Each one of the surge monitoring devices 902, 904, 906 may transmit information as described above with respect to FIGS. 1 and 2. To illustrate, the surge monitoring devices 902, 904, 906 may each transmit information that includes one or more of detections of transient spikes, timestamps indicating times of transient spike detections, amplitude range of detected transient spikes, durations of transient spikes, the number of detected transient spikes, expected failures of surge suppression circuits monitored by the surge monitoring devices 902, 904, 906, etc.

In some example embodiments, the remote server 908, which may be a cloud server, may process the information received from the surge monitoring devices 902, 904, 906, and take other actions. For example, the remote server 908 may keep track of detections of transient spikes by one or more of the surge monitoring devices 902, 904, 906 and may determine whether associated surge suppression circuits are close to failure in a similar manner as described above with respect to surge monitoring circuit 104.

In some example embodiments, the remote server 908 provide a notification of the expected failure of a particular surge suppression circuit based on the analysis of detections of transient spikes by the surge monitoring devices 902, 904, or 906 that is associated with the particular surge suppression circuit. For example, the remote server 908 may display a notification message on a display screen and/or transmit a notification message to a user device, such as a mobile device, a tablet, a laptop, etc. wirelessly and/or via a wired connection. In some example embodiments, the remote server 908 may provide a notification of the expected failure of a particular surge suppression circuit based on a notification received from the surge monitoring devices 902, 904, or 906 that is associated with the particular surge suppression circuit. For example, the remote server 908 may display a notification message on a display screen and/or transmit a notification message to a user device.

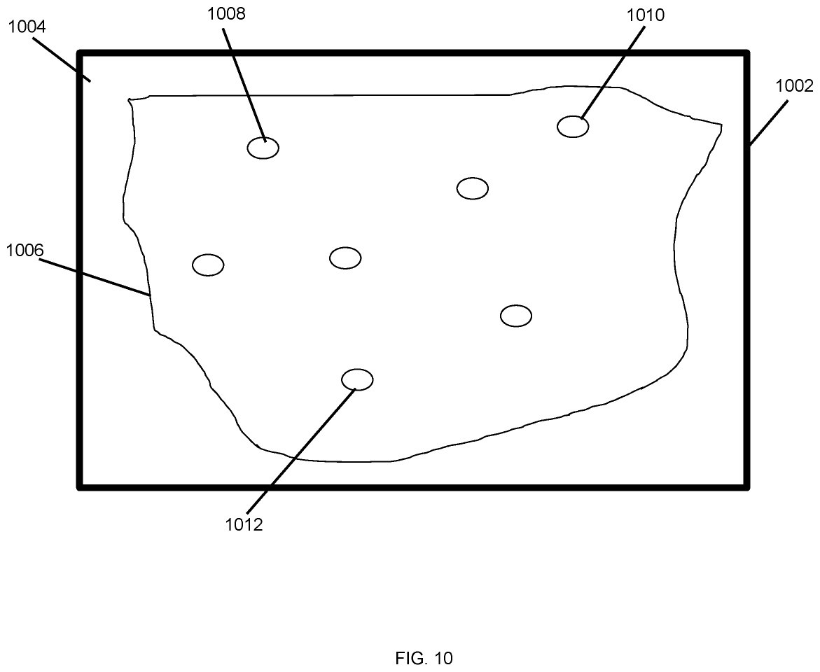

In some example embodiments, the remote server 908 may display a map, such as a map 1006 shown in FIG. 10, showing surge monitoring devices. For example, the remote server 908 may display the map 1006 on a display screen 1004 of a device 1002 (e.g., a monitor). FIG. 10 illustrates the geographic map 1006 of an area with surge monitoring devices according to another example embodiment. Referring to FIGS. 9 and 10, in some example embodiments, the geographic map 1006 may be a map of a neighborhood, a city, a state, a country, etc.

In some example embodiments, in the map 1006, icons 1008, 1010, 1012, etc. may each correspond to individual surge monitoring devices and associated surge suppression circuits. For example, the icon 1008 may correspond to the surge monitoring device 902 and its associated surge suppression circuit, the icon 1010 may correspond to the surge monitoring device 904 and its associated surge suppression circuit, and the icon 1012 may correspond to the surge monitoring device 906 and its associated surge suppression circuit. To illustrate, if the particular surge suppression circuit associated with the surge monitoring device 902 is close to failure as determined based on the detection of transient spikes by the surge monitoring device 902, the remote server 908 may cause the icon 1008 to be displayed in a manner that is indicative of the expected failure of the particular surge suppression circuit. For example, the icon 1008 may blink while the icons 1010, 1012 associated with surge suppression circuits that are not expected to fail do not blink. As another example, the icon 1008 may have a particular color (e.g., red) while the icons 1010, 1012 associated with surge suppression circuits that are not expected to fail have a different color (e.g., green).

In some example embodiments, the icons 1008, 1010, 1012 may represent clusters of surge suppression circuits and associated surge monitoring devices and may be displayed in a manner that indicates the frequency and/or strengths of transient spikes that are detected by the surge monitoring devices. For example, icons representing clusters of surge suppression circuits that experience a high frequency of transient spikes (e.g., because the location of the surge suppression circuits experiences frequent lighting) may have a one color (e.g., red). Icons representing clusters of surge suppression circuits that experience a medium frequency of transient spikes may have a different color (yellow), and icons representing clusters of surge suppression circuits that experience a low frequency of transient spikes may have a different color (green). In general, information related to transient spikes detected by the surge monitoring devices 902, 904, 906 as well as other surge monitoring devices may be used to display information on the map 1006 using the icons 1008, 1010, 1012, or other display means (e.g., text) as can be contemplated by those of ordinary skill in the art with the benefit of this disclosure.

By using and analyzing information received from the surge monitoring devices 902, 904, 906, etc., the system 900 may provide notifications that enable planned replacements of surge suppression circuits/devices, such as the surge suppression circuit 102, to avoid unexpected failures that can result in damages to load devices. By providing information (e.g., displaying) about the frequency of transient spikes with respect to surge suppression circuits/devices, types of surge suppression circuits/devices that are better suited to a particular location of a geographic area may be selected.

In some example embodiments, the system 900 may include more or fewer surge monitoring devices than shown without departing from the scope of this disclosure. In some alternative embodiments, system 900 may include a local server instead of or in addition to the remote server 908 without departing from the scope of this disclosure. In some alternative embodiments, the map 1006 may include more or fewer icons or other display representations without departing from the scope of this disclosure.

Although example embodiments have been described, it is to be construed that any features and modifications that are applicable to one embodiment are also applicable to the other embodiments. Furthermore, although the disclosure has been described with reference to specific embodiments, these descriptions are not meant to be construed in a limiting sense. Various modifications of the disclosed embodiments, as well as alternative embodiments of the disclosure will become apparent to persons of ordinary skill in the art upon reference to the description of the example embodiments. It should be appreciated by those of ordinary skill in the art that the conception and the specific embodiments disclosed may be readily utilized as a basis for modifying or designing other structures or methods for carrying out the same purposes of the disclosure. It should also be realized by those of ordinary skill in the art that such equivalent constructions do not depart from the spirit and scope of the disclosure as set forth in the appended claims. It is therefore, contemplated that the claims will cover any such modifications or embodiments that fall within the scope of the disclosure.

What is claimed is:

1. A surge monitoring circuit for detecting transient spikes in an input voltage, the surge monitoring circuit comprising:
a voltage divider circuit that generates a divider output voltage from the input voltage;
a reference voltage generator circuit that generates one or more reference voltages;
a comparator circuit that generates one or more comparator signals by comparing the divider output voltage to the one or more reference voltages; and
a processor configured to predict, at least based on the one or more comparator signals, an expected failure of a surge suppressor circuit that suppresses the transient spikes, wherein the one or more comparator signals indicate one or more detections of one or more divider output transient spikes in the divider output voltage, wherein the one or more divider output transient spikes correspond to one or more transient spikes of the transient spikes and wherein the one or more divider output transient spikes have a higher voltage than the one or more reference voltages.

2. The surge monitoring circuit of claim 1, further comprising a power supply device that generates a supply voltage from the input voltage, wherein the reference voltage generator circuit generates the one or more reference voltages from the supply voltage.

3. The surge monitoring circuit of claim 1, wherein the processor is configured to predict the expected failure of the surge suppressor circuit at least based on a number of the one or more divider output transient spikes.

4. The surge monitoring circuit of claim 3, wherein the processor is configured to predict the expected failure of the surge suppressor circuit further based on one or more amplitudes of the one or more divider output transient spikes.

5. The surge monitoring circuit of claim 3, wherein the processor is configured to predict the expected failure of the surge suppressor circuit further based on one or more durations of the one or more divider output transient spikes at a voltage level of the divider output voltage.

6. The surge monitoring circuit of claim 5, wherein the comparator circuit generates one or more pulses having one or more pulse widths indicative of the one or more durations of the one or more divider output transient spikes at the voltage level of the divider output voltage.

7. The surge monitoring circuit of claim 6, wherein the processor is configured to transmit, via a wired or wireless signal, information indicating the one or more detections of one or more divider output transient spikes and the one or more durations of the one or more divider output transient spikes.

8. The surge monitoring circuit of claim 7, wherein the processor is configured to transmit, via the wired or wireless signal, time information indicative of one or more times corresponding to the one or more detections of one or more divider output transient spikes.

9. The surge monitoring circuit of claim 1, wherein the processor is configured to transmit, via a wired or wireless signal, a notification indicating the expected failure of the surge suppressor circuit.

10. The surge monitoring circuit of claim 1, wherein the processor is configured to generate one or both of a visual notification and an audio notification that indicate the expected failure of the surge suppressor circuit.

11. A surge suppression and monitoring device, the surge suppression and monitoring device comprising:
a surge suppressor circuit to suppress transient spikes in an input voltage; and
a surge monitoring circuit, comprising:
a voltage divider circuit that generates a divider output voltage from the input voltage;
a reference voltage generator circuit that generates one or more reference voltages;
a comparator circuit that generates one or more comparator signals by comparing the divider output voltage to the one or more reference voltages; and
a processor configured to predict an expected failure of the surge suppressor circuit at least based on the one or more comparator signals.

12. The surge suppression and monitoring device of claim 11, further comprising a power supply device that generates a supply voltage from the input voltage, wherein the reference voltage generator circuit generates the one or more reference voltages from the supply voltage.

13. The surge suppression and monitoring device of claim 11, wherein the one or more comparator signals indicate one or more detections of one or more divider output transient spikes in the divider output voltage and wherein the one or more divider output transient spikes correspond to one or more transient spikes of the transient spikes.

14. The surge suppression and monitoring device of claim 13, wherein the processor is configured to predict the expected failure of the surge suppressor circuit based on one or more amplitudes of the one or more divider output transient spikes.

15. The surge suppression and monitoring device of claim 14, wherein the processor is configured to predict the expected failure of the surge suppressor circuit further based on one or more durations of the one or more divider output transient spikes at a voltage level of the divider output voltage.

16. The surge suppression and monitoring device of claim 11, wherein the input voltage is in a range of 120 VAC to 277 VAC when no transient spikes are present in the input voltage and wherein the divider output voltage is approximately one-ten thousandth of the input voltage.

17. A method of monitoring transient spikes in an input voltage, the method comprising:
generating, by a voltage divider circuit, a divider output voltage from the input voltage, wherein the divider output voltage includes one or more divider output transient spikes that correspond to one or more transient spikes of the transient spikes;
generating, by a reference voltage generator circuit, one or more reference voltages;
generating, by a comparator circuit, one or more comparator signals by comparing the divider output voltage to the one or more reference voltages; and
providing, by a processor, a notification indicating an expected failure of a surge suppressor circuit that suppresses the one or more transient spikes, wherein the processor is configured to predict the expected failure of the surge suppressor circuit at least based on the one or more comparator signals.

18. The method of claim 17, further comprising generating, by a power supply device, a supply voltage from the input voltage, wherein the one or more reference voltages are generated by the reference voltage generator circuit from the supply voltage.

19. The method of claim 17, wherein the one or more comparator signals indicate one or more detections of the one or more divider output transient spikes and wherein the processor is configured to predict the expected failure of the surge suppressor circuit based on one or more amplitudes of the one or more divider output transient spikes.

20. The method of claim 17, wherein the processor is configured to predict the expected failure of the surge suppressor circuit further based on one or more durations of the one or more divider output transient spikes at a voltage level of the divider output voltage.
